(19) United States
(12) Patent Application Publication
(10) Pub. No.: US 2025/0059656 A1
(43) Pub. Date: Feb. 20, 2025

(54) METHOD FOR SEALING AN ELECTROLYSIS CELL AND SEALED ELECTROLYSIS CELL

(71) Applicant: thyssenkrupp nucera AG & Co. KGaA, Dortmund (DE)

(72) Inventors: Peter TOROS, Essen (DE); Sebastian AUSTENFELD, Soest (DE)

(73) Assignee: thyssenkrupp nucera AG & Co. KGaA, Dortmund (DE)

(21) Appl. No.: 18/717,708

(22) PCT Filed: Dec. 6, 2022
(86) PCT No.: PCT/EP2022/084645

§ 371 Date: Jun. 7, 2024

(30) Foreign Application Priority Data
Dec. 8, 2021 (EP) 21213033.0

(51) Int. Cl. C25B 9/19; C09J 123/12; C09J 127/06; C25B 9/05; C25B 9/60

(52) U.S. Cl. CPC C25B 9/19; C09J 123/12; C09J 127/06; C25B 9/60; C25B 9/05

(57) ABSTRACT

A method for sealing an electrolysis cell comprising an anode half-cell and a cathode half-cell formed by at least two cell elements and a sheet-like separator separating the half-cells from one another comprises providing the two cell elements and the sheet-like separator, interposing the separator between the two cell elements and interposing a layer of sealing material between each side of the separator and the two cell elements in a respective rim region of the cell elements, and sealing the electrolysis cell, wherein a force is applied to the cell elements to compress the rim regions, wherein the sealing material is an electrically isolating material and during the sealing step the state of the sealing material is changed from a liquid state to a solid state to create an adhesive bond between the cell elements and the interposed separator by the sealing material, wherein the force is relieved after the sealing material has solidified.

### BACKGROUND OF THE INVENTION

The invention relates to a method for sealing an electrolysis cell according to the preamble of claim 1 and a sealed electrolysis cell according to the preamble of claim 7.

Bipolar electrolyzers for large-scale production of hydrogen and/or chlorine (i.e. in the megawatt range) can be classified in two major design categories, namely filter press design and single element design.

In a conventional filter press electrolyzer, a stack of electrolysis cells is formed in a cell rack by stacking a plurality of cell elements under interposition of sheet-like separators and gaskets between adjacent cell elements and compressing the complete stack in order to seal all electrolysis cells at once. In electrolyzers of filter press design, each cell element forms the anode half-cell of one electrolysis cell and the cathode half-cell of a neighboring electrolysis cell in the stack. The sealing force for all cells is provided by tie-rods extending along the stack.

In an electrolyzer of single element design, each electrolysis cell is a separately sealed unit. Each electrolysis cell comprises two cell elements in the form of half-shells, which are bolted together in their rim regions, with a separator and gaskets interposed in-between. Thus, each cell element forms one half-cell of the electrolysis cell, the half-cells being separated by the separator. The sealing force for sealing the electrolysis cell is provided by the plurality bolts distributed circumferentially along the rim regions of the cell elements.

In both design options, the separator may be an ion exchange membrane, or a porous diaphragm, depending of the intended purpose of the electrolyzer. Further, in both design options a short-circuit between the two cell elements forming each electrolysis cell is to be reliably prevented, for which reason in addition to the gaskets usually at least one layer of electrically isolating material is interposed in the rim regions before sealing.

US 2011/0259735 A1 shows examples of the filter press design and the single element design of bipolar electrolyzers.

The known types of bipolar electrolyzers have the disadvantage that sealing of the cells causes a high assembly effort. Although in filter press electrolyzers the sealing force for all cells is provided by the same set of tie-rods, sealing of the cell stack is complicated and time-consuming since all separators, gaskets and isolation layers have to be correctly positioned at once. Single element electrolyzers require a high number of bolted connections for each element in order to prevent safely leakage during operation. Further, the space requirements for the structural elements needed to provide the sealing forces reduces the space available for cell volume, and in particular in the single element design the conventional sealing arrangement sets a lower limit for the thickness of each element.

### BRIEF SUMMARY OF INVENTION

The object of the invention is to provide a method for sealing an electrolysis cell and a sealed electrolysis cell with a lower assembly effort and reduced space requirements of the sealing arrangement.

This object is achieved by the method for sealing an electrolysis cell according to the features of claim 1 and a sealed electrolysis cell with the features of claim 7.

Hereby, a method for sealing an electrolysis cell comprising an anode half-cell and a cathode half-cell formed by at least two cell elements and a sheet-like separator separating the half-cells from one another is provided, the method comprising the following steps:
providing the two cell elements and the sheet-like separator,
interposing the separator between the two cell elements and interposing a layer of sealing material between each side of the separator and the two cell elements in a respective rim region of the cell elements,
sealing the electrolysis cell, wherein a force is applied to the cell elements to compress the rim regions.

According to the invention, the sealing material is an electrically isolating material, and during the step of sealing the state of the sealing material is changed from a liquid state to a solid state to create an adhesive bond between the cell elements and the interposed separator by means of the sealing material. The force is relieved after the sealing material has solidified.

By using an adhesive bond of the cell elements to seal the electrolysis cell, assembly of the cell is simplified, since placing and fastening bolts is no longer necessary. Moreover, due to the electrically isolating properties of the adhesive, a separate isolation layer can be dispensed with. The method according to the invention is particularly well suited for an automatized manufacturing of electrolysis cells. In addition, it enables electrolyzers of the filter press type to be assembled on a cell-by-cell basis, since the sealing forces according to the invention are provided by the adhesive bond between the sealing material and the cell elements. Thus, no external forces to compress the stack are needed to seal the cells any more. Moreover, since external structural elements are no longer needed to maintain the sealing forces, the space requirements of the inventive sealing arrangement are particularly low, allowing for further reduction of the cell thickness.

In some embodiments, the sealing material is a chemically curing adhesive or a solvent-based adhesive. Chemically curing and solvent-based adhesives have the advantage of a particularly strong adhesive bonding, which is able to withstand high temperatures and/or harsh chemicals. When using adhesives as sealing material, the layers of sealing material are preferably interposed by applying the adhesive in a viscous liquid state to the rim regions of both cell elements.

In other embodiments, the sealing material is a thermoplastic material, wherein the step of sealing the electrolysis cell comprises:
inputting energy to the sealing material to bring the sealing material into a thermo-plastic state,
bonding the cell elements and the interposed separator while the sealing material is in the thermoplastic state, and
lowering the temperature of the sealing material to let the sealing material solidify.

Thermoplastic materials have the advantage that they allow for the possibility to open and reseal the electrolysis cell in an easy and non-destructive way. For maintenance purposes, as e.g. replacement of the separators, the rim regions can be heated up until the thermoplastic material is in the thermoplastic state again and the cell elements can be separated.

When thermoplastic materials are used as sealing material, the adhesive bond may be created in a two-step process, wherein the layers of sealing material are first bonded to the cell elements and wherein the two layers of sealing material are then bonded to each other and to the separator in the step of sealing. The first bond may for example already be present, when the two cell elements are provided, i.e. the cell elements are provided with a coating of thermoplastic material in their rim regions. Alternatively, the first bond may be created during the step of interposing the sealing material, or during the step of sealing.

The thermoplastic material can be brought into the thermoplastic state by different types of energy supply. In the simplest case, the energy is input by heating of the rim regions. Another possible way to input the energy is thermowelding of the layers of sealing material by means of ultrasound.

Particularly preferred for sealing the electrolysis cells are thermoplastic materials that contain polypropylene (PP), in particular atactic polypropylene (PP-R), and/or polyvinylchloride (PVC).

Preferably, the step of sealing further comprises folding the rim regions of the cell elements backwards to one side. The backward fold of both rim regions to the same side, e.g. by 120° to 180°, achieves a mechanical entanglement of the cell elements that further supports the sealing of the cell. In particular, the fold is advantageous in electrolysis cells to be operated at an elevated internal pressure, since the fold relieves the adhesive bond from the pressure force by a form lock.

In preferred embodiments, the cell elements are made of a metal sheet having a thickness of less than or equal to 0.8 mm. Preferred metals are nickel and/or titanium. Due to the sealing concept according to the invention, it is even imaginable to produce electrolysis cells from metal foils having a thickness of less than or equal to 0.2 mm.

The problem is further solved by a sealed electrolysis cell comprising an anode half-cell and a cathode half-cell formed by at least two cell elements and a sheet-like separator separating the half-cells from one another. The cell elements each have a rim region and are attached to each other in the rim regions under interposition of a layer of sealing material between each side of the separator and the two cell elements in an electrically isolated and sealed manner. According to the invention the sealing material is a solidified liquid material forming an adhesive bond between the cell elements and providing electric isolation and sealing of the cell elements.

A major advantage of the sealed electrolysis cell of the invention is that the sealing forces are provided by an adhesive bond and external structural elements to maintain the sealing forces can be dispensed with. Thus, electrolyzers using this type of electrolysis cell better make use of the available space and the cells can be operated under less mechanical stress. Further, the sealing arrangement is no longer limiting the possibility to design electrolysis cell of reduced thickness.

In certain embodiments, the sealing material is a chemically cured adhesive or a dried solvent-based adhesive.

In other embodiments, the sealing material is a thermoplastic material. In particular, it is preferred that the sealing material contains polypropylene (PP) and/or polyvinylchloride (PVC).

In preferred embodiments, the edges of the sheet-like separator are immersed within the solidified sealing material. Thus, also risks of leakage due to capillary effects of the separator can be avoided. This is in particular advantageous if porous diaphragms are used as separator, since porous diaphragms are known to cause leakages issues by capillary forces, if they extend between the rim regions of the cell elements to the outside of the cell.

Further, it is preferred that the rim regions of the cell elements are fold backwards to one side, so as to provide a mechanical form lock between the cell elements.

The cell elements are preferably made of a metal sheet having a thickness of less than or equal to 0.8 mm, in particular less than or equal to 0.2 mm. Preferred metals are nickel and/or titanium.

In particular, the invention relates to electrolysis cells of industrial scale. The separator of the electrolysis cell according to the invention therefore preferably has an area of 0.5 m² to 4 m². Further, the electrolysis cell is preferably configured for current densities of at least 3 kA/m².

Further advantages of the invention are described in the following with regard to the embodiments shown in the attached drawings.

### BRIEF DESCRIPTION OF DRAWINGS

FIG. 1 shows schematically a flow diagram illustrating the inventive method for sealing an electrolysis cell,

FIG. 2A to 2C show schematically different stages of the production of sealed electrolysis cells of the single element type according to the invention,

FIGS. 3A and 3B show schematically different stages of the production of a sealed electrolysis cell of the filter press type according to the invention.

### DETAILED DESCRIPTION OF INVENTION

In the drawings same parts are consistently identified by the same reference signs and are therefore generally described and referred to only once.

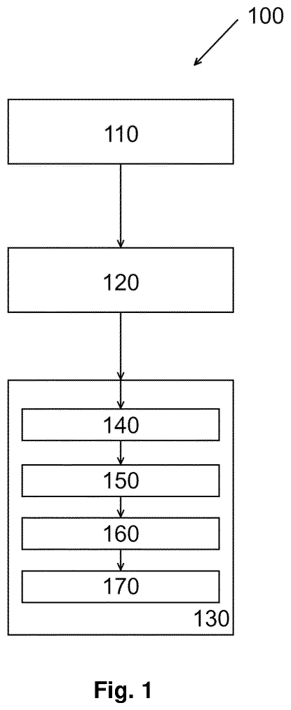

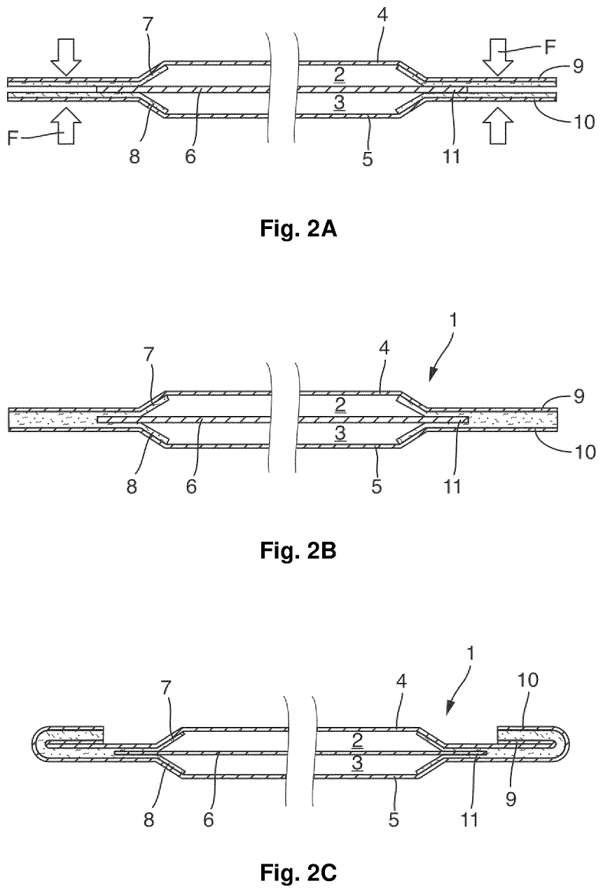

In FIG. 1, a flow diagram of the method 100 for sealing an electrolysis cell is shown, illustrating the sequence of the steps in an abstract manner. FIG. 2A shows an electrolysis cell in a state before the sealing step of the method and FIG. 2B shows an embodiment of the sealed electrolysis cell 1. FIG. 2C shows a different embodiment of the sealed electrolysis cell 1 with backwards folded rim regions. The method steps will be described in the following with reference to FIGS. 1 and 2A to 2C.

According to the inventive method in step 110 two cell elements 4, 5 and a sheet-like separator 6 are provided. In step 120 the separator 6 is interposed between the two cell elements 4, 5 and a layer of sealing material 7, 8 is interposed between each side of the separator 6 and the two cell elements 4, 5 in a respective rim region 9, 10 of the cell elements 4, 5. FIG. 2A shows the electrolysis cell in an assembly stage after step 120.

In step 130 the electrolysis cell 1 is sealed, wherein a force F is applied to the cell elements 4, 5 to compress the rim regions 9, 10. The sealing material 7, 8 is an electrically isolating material and during the sealing step 130 the state of the sealing material 7, 8 is changed from a liquid state to a solid state to create an adhesive bond of the cell elements 4, 5 and the interposed separator 6 by means of the sealing material 7, 8. The force F is relieved after the sealing material 7, 8 has solidified. FIG. 2B shows the sealed electrolysis cell 1 after step 130.

The sealing material 7, 8 may be a chemically curing adhesive or a solvent-based adhesive.

In the method shown in FIG. 1, the sealing material 7, 8 is a thermoplastic material. The step of sealing 130 of the electrolysis cell 1 therefore further comprises a step of inputting energy 140 to the rim regions 9, 10 to bring the sealing material 7, 8 into a thermoplastic state, a step of bonding 150 the cell elements 4, 5 and the interposed separator 6 while the sealing material 7, 8 is in the thermoplastic state, and a step of lowering the temperature 160 of the sealing material 7, 8 to let the sealing material 7, 8 solidify. Preferably, the sealing material 7, 8 contains polypropylene (PP) and/or polyvinylchloride (PVC).

For example, the energy may be input by heating of the rim regions 9, 10 to a temperature at which the sealing material is in its thermoplastic state. Lowering the temperature of the sealing material 7, 8 may e.g. be achieved by letting the temperature settle to the ambient temperature, or by an active cooling of the rim regions 9, 10.

Preferably, as shown in FIG. 1 the step of sealing 130 further comprises folding 170 of the rim regions 9, 10 of the cell elements 4, 5 backwards to one side of the separator. The folding 170 may be carried out either after the sealing material has solidified, or before. In particular, if a chemically curing adhesive or a solvent-based adhesive is used, folding 170 is preferred to be carried out before the adhesive has solidified. FIG. 2C shows an embodiment of the sealed cell 1 after the step of folding 170.

A sealed electrolysis cell 1 manufactured according to the inventive method is shown in FIG. 2B. The sealed electrolysis cell 1 comprises an anode half-cell 2 and a cathode half-cell 3 formed by at least two cell elements 4, 5 and a sheet-like separator 6 separating the half-cells 2, 3 from one another.

The anode half-cell 2 and the cathode half-cell 3 contain an anode and a cathode, respectively (not shown). The anode and the cathode may be joined to the respective cell element 4, 5 in one piece, or may be configured as separate components.

The cell elements 4, 5 each have a rim region 9, 10 and are attached to each other in the rim regions 9, 10 under interposition of a layer of sealing material 7, 8 between each side of the separator 6 and the two cell elements 4, 5 in an electrically isolated and sealed manner. The sealing material 7, 8 of the sealed cell 1 is a solidified liquid material forming an adhesive bond between the cell elements 4, 5 and providing electric isolation and sealing of the cell elements 4, 5.

The solidified sealing material is a chemically cured adhesive or a dried solvent-based adhesive. Alternatively, the sealing material can be a thermoplastic material. In particular, the sealing material may contain polypropylene (PP) and/or polyvinylchloride (PVC).

As shown in FIG. 2B, the edges 11 of the sheet-like separator 6 are preferably immersed within in the solidified sealing material. Thus, the sheet-like separator 6 does not extend through the rim regions 9, 10 to the outside of the cell, but is confined in a form-fitting manner within the adhesive bond between the cell elements 4, 5.

The cell elements 4, 5 are preferably made of a metal sheet having a thickness of less than or equal to 0.8 mm. In particular it is imaginable that the cell elements are made of a metal foil having a thickness of less than or equal to 0.1 mm. Preferred metals are nickel and titanium.

The electrolysis cell 1 is preferably configured for alkaline water electrolysis or chlor-alkali electrolysis.

FIG. 2C shows an embodiment of the sealed electrolysis cell 11, in which the rim regions 9, 10 of the cell elements 4, 5 are fold backwards to one side. In all other respects, the description of the embodiment shown in FIG. 2A is applicable to the embodiment shown in FIG. 2B, accordingly.

The embodiments of FIGS. 2B and 2C relate to electrolysis cells 1 of the single element de-sign. The electrolysis cells 1 are configured as separate units, which can be connected electrically in series by abutting the backsides of the cell elements 4, 5 to an adjacent cell. Thereby, a stack of electrolysis cell 1 can be built and provided with power supply on the outer sides of the outmost cells of the stack.

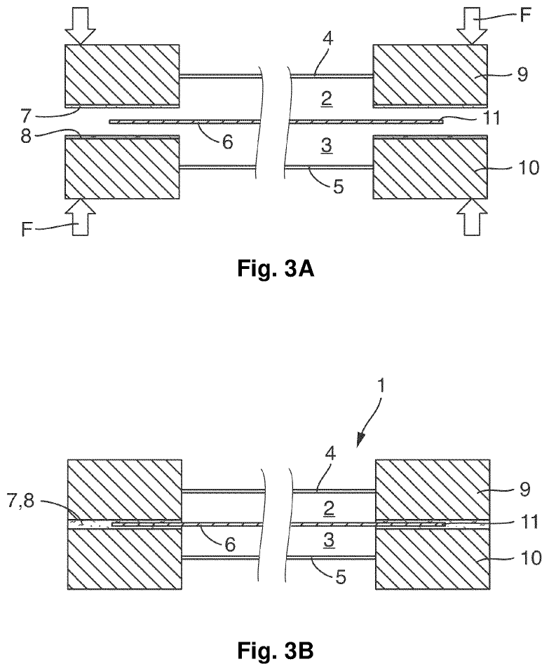

FIGS. 3A and 3B show an embodiment of the method and the sealed cell 1 of the filter press type. Each cell element 4, 5 provides an anode half-cell 2 and a cathode half-cell 3 of an adjacent cell. A plurality of cell elements 4, 5 can be sealed one-by-one to each other under interposition of one separator 6 each to for a stack of electrolysis cells 1 of the filter press type.

In all other respects, the description of the embodiments shown in FIGS. 2A and 2B is applicable to the embodiments shown in FIGS. 3A and 3B, accordingly.

### LIST OF REFERENCE SIGNS

1 electrolysis cell
2 anode half-cell
3 cathode half-cell
4, 5 cell elements
6 separator
7,8 sealing material
9, 10 rim region
11 edge of separator
100 method for sealing an electrolysis cell
110 providing cell elements and separator
120 interposing separator and sealing material between cell elements
130 sealing the electrolysis cell
140 inputting energy to the rim regions
150 bonding cell elements and separator
160 lowering the temperature of rim regions
170 folding the rim regions
F compressive force

1-14. (canceled)

15. A method for sealing an electrolysis cell comprising an anode half-cell and a cathode half-cell formed by at least two cell elements and a sheet-like separator separating the half-cells from one another, the method comprising:
providing the two cell elements and the sheet-like separator;
interposing the separator between the two cell elements and interposing a layer of sealing material between each side of the separator and the two cell elements in a respective rim region of the cell elements; and
sealing the electrolysis cell, wherein a force is applied to the cell elements to compress the rim regions;
wherein the sealing material is an electrically isolating material, wherein during the sealing the state of the sealing material is changed from a liquid state to a solid state to create an adhesive bond between the cell elements and the interposed separator by the sealing material, wherein the force is relieved when the sealing material has solidified.

16. The method according to claim 15, wherein the sealing material is a chemically curing adhesive or a solvent-based adhesive.

17. The method according to claim 15, wherein the sealing material is a thermoplastic material, wherein the sealing the electrolysis cell comprises:
inputting energy to the sealing material to bring the sealing material into a thermoplastic state,
bonding the cell elements and the interposed separator while the sealing material is in the thermoplastic state, and
lowering the temperature of the sealing material to let the sealing material solidify.

18. The method according to claim 17, wherein the energy is input by heating or ultrasound.

19. The method according to claim 17, wherein the sealing material contains polypropylene and/or polyvinylchloride.

20. The method according to claim 15, wherein the sealing further comprises folding the rim regions of the cell elements backwards to one side.

21. The method according to claim 15, wherein the cell elements are made of a metal sheet having a thickness of less than or equal to 0.8 mm.

22. The method according to claim 15, wherein the cell elements are made of a metal sheet having a thickness of less than or equal to 0.2 mm.

23. A sealed electrolysis cell, comprising:
an anode half-cell and a cathode half-cell formed by at least two cell elements and a sheet-like separator separating the half-cells from one another,
wherein the cell elements each have a rim region and are attached to each other in the rim regions under interposition of a layer of sealing material between each side of the separator and the two cell elements in an electrically isolated and sealed manner, wherein the sealing material is a solidified liquid material forming an adhesive bond between the cell elements and providing electric isolation and sealing of the cell elements.

24. The sealed electrolysis cell according to claim 23, wherein the sealing material is a chemically cured adhesive or a dried solvent-based adhesive.

25. The sealed electrolysis cell according to claim 23, wherein the sealing material is a thermoplastic material.

26. The sealed electrolysis cell according to claim 25, wherein the sealing material contains polypropylene and/or polyvinylchloride.

27. The sealed electrolysis cell according to claim 23, wherein edges of the sheet-like separator are immersed within the solidified sealing material.

28. The sealed electrolysis cell according to claim 23, wherein the rim regions of the cell elements are folded backwards to one side.

29. The sealed electrolysis cell according to claim 23, wherein the cell elements are made of a metal sheet having a thickness of less than or equal to 0.8 mm.

30. The sealed electrolysis cell according to claim 23, wherein the cell elements are made of a metal sheet having a thickness of less than or equal to 0.2 mm.
